(19) United States
(12) Patent Application Publication
(10) Pub. No.: US 2011/0119141 A1
(43) Pub. Date: May 19, 2011

(54) Siccolla Identity Verification Architecture and Tool

(75) Inventors: Hector T. Hoyos, New York, NY (US); Keith J. Hanna, New York, NY (US)

(73) Assignee: Hoyos Corporation, Caguas, PR (US)

(21) Appl. No.: 12/942,106

(22) Filed: Nov. 9, 2010

Related U.S. Application Data
(60) Provisional application No. 61/281,257, filed on Nov. 16, 2009.

(51) Int. Cl. G06Q 20/00

(52) U.S. Cl. 705/17; 705/16

(57) ABSTRACT

Siccolla is an identity verification architecture utilizing wireless phones as an identity verification tool. The wireless phone has a specialized built-in fingerprint sensor, camera, and blood sensor to acquire high quality images of biometrics, including but not limited to the iris, face and fingerprints, as well as DNA sampling, to perform identity verification via biometric recognition to secure credit card/debit card/financial instruments and general multi-purpose local and/or remote identity verification transactions at the Point-of-Sale terminals (POS), online for E-Commerce, and at any general purpose point of transaction at which a positive identity verification in real time must occur to prevent identity theft and financial fraud and enable commerce, E-Commerce, or general access or business to proceed and prosper. In doing so the system also feeds the biometrics obtained of all those individuals fraudulently attempting to utilize someone else's identity into a database, creating a watch list of fraudsters against which institutions can verify any and all of the identity of any and all individuals that they come across in the line of their business, to protect themselves from financial losses, fraud, and/or physical events or actions which may cause harm to themselves, their physical and logical facilities, as well as all their customers, employees, and/or innocent bystanders.

### CROSS-REFERENCE TO RELATED APPLICATIONS

This application claims benefit from provisional application 61/281,257 filed Nov. 11, 2009, which is hereby incorporated by reference in its entirety.

### BACKGROUND OF THE INVENTION

Identity theft is often committed to facilitate other crimes, frauds, and terrorism. Therefore, preventing identity theft could proactively prevent other crimes, including physical, electronic, or economic terrorism. Unfortunately, best practices suggested to prevent identity theft such as presenting a traditional valid government issued ID, confirming that the website where you give out your credit card information is secure, or using common sense in responding to special offers over the Internet, are not convenient, prone to human error, do not provide 100% identity security and thus are ineffective.

As an attempted solution, biometric methods have been developed whereby measurements of the face, iris or fingerprint, as examples, are used to associate a transaction to an individual. However they have not been successfully deployed in a widespread fashion for several reasons, including the typical requirement for the bank transaction system infrastructure to manage biometric information, which has required substantial modification to bank infrastructure as well as the development of bank procedures and protocols to manage and protect biometric information, which is typically an area outside the expertise of banks.

### SUMMARY OF THE INVENTION

The invention executes and splits up the transaction into 2 components: the biometric component, and the financial component. The separation of the transaction is designed in the invention such that no or minimal changes to the design of an existing non-biometric financial transaction backend server are required. It also allows the biometric component of the transaction to be managed, protected and operated independently from the financial institution that manages the financial transaction backend server.

### BRIEF DESCRIPTION OF THE DRAWINGS

FIG. 1 shows a transaction at a point of sale utilizing the biometric server and the financial transaction server.

FIG. 2 shows a transaction at a computer utilizing the biometric server and the financial transaction server.

FIG. 3 shows the point-of-sale transaction approach and the online computer transaction approach operating with 3 different payment processor institutions: (a) For credit cards/debit cards/financial instruments issued by small-midsize banks, a third party processor (“switch”); (b) For credit cards/debit cards/financial instruments issued by small-midsize banks, the credit card company; and (c) For credit cards/debit cards/financial instruments issued by large banks, the banks themselves.

### DETAILED DESCRIPTION OF THE INVENTION

Identity theft is often committed to facilitate other crimes, frauds, and terrorism. Therefore, preventing identity theft could proactively prevent other crimes, including physical, electronic, or economic terrorism. Unfortunately, best practices suggested to prevent identity theft such as presenting a traditional valid government issued ID, confirming that the website where you give out your credit card information is secure, or using common sense in responding to special offers over the Internet, are not convenient, prone to human error, do not provide 100% identity security and thus are ineffective.

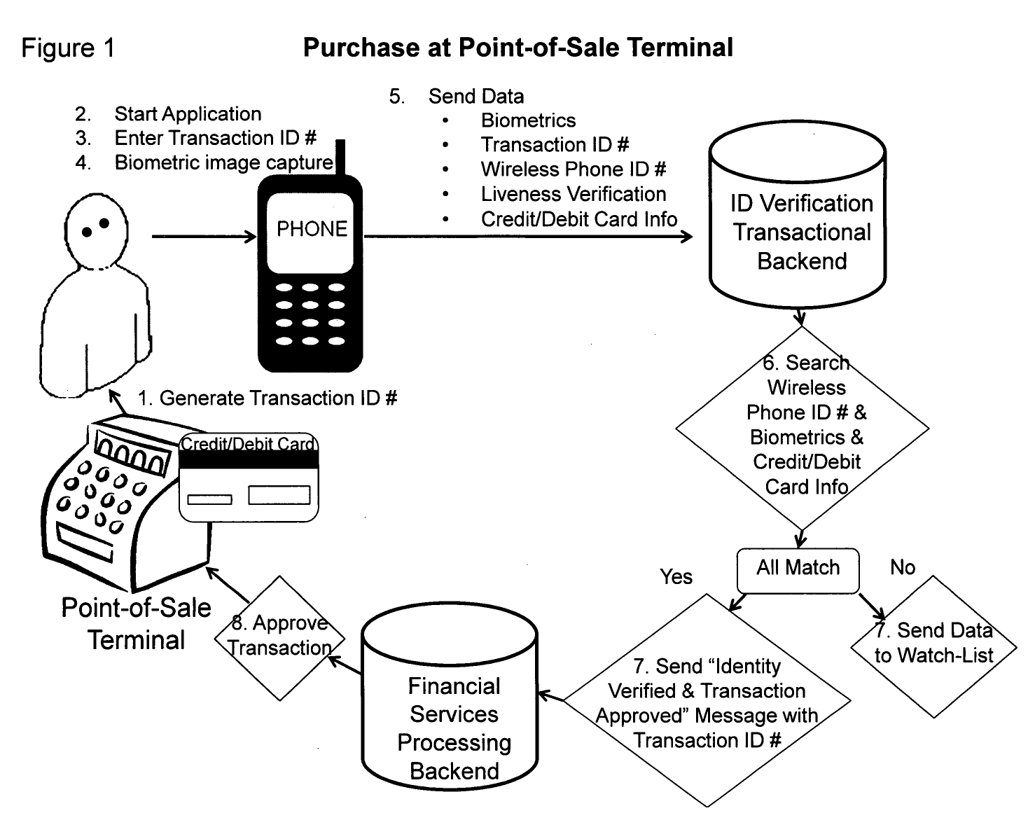

An approach for a secure point-of-sale transaction is illustrated in FIG. 1. The customer that has signed up for the service and has provided his/her biometrics, credit card/debit card/financial instrument and/or information and a unique ID code assigned to his/her wireless phone pays with his/her credit card/debit card/financial instrument and/or information at the point-of-sale terminal. A unique transaction ID number is assigned to the transaction. The customer initiates a dedicated application on his/her wireless phone and enters the transaction ID number. Then the customer acquires imagery of his/her biometrics with his/her phone. The application then fuses the transaction ID number with the biometric imagery acquired, along with the wireless phone ID number and a liveness verification of the biometric(s) acquired. The liveness verification is a method of ensuring that the biometrics just acquired are of an actual person and not from a photo or video.

The application then transmits the fused data to an “ID Verification Transactional Backend” which communicates with a database holding the enrolled individuals' biometrics, credit card/debit card/financial information and wireless phone ID numbers as fused virtual packets. These data packets are indexed based on the wireless phone ID number.

The ID Verification Transactional Backend first performs a search of the wireless phone ID number against the ones stored in the database. Upon a match, the database proceeds to perform a search of the biometrics against those stored in the database for that wireless phone ID, followed by the same process for the credit card/debit card/financial information. A match at all three stages of the search returns an “identity verified” message.

The ID Verification Transactional Backend then sends an “Identity Verified” message to the Financial Services Processing Backend which may be at a different physical location, along with the ID number of the transaction that is being processed for which the specific individual's identity has been verified. The Financial Services Processing Back-end then approves the transaction at the point-of-sale terminal and completes the purchase.

A no-match at any of the three stages of the search by the ID Verification Transactional Back-end leads to an “Identity Not Verified” message to the Financial Services Processing Backend which in turn does not authorize the POS transaction. A no-match, in the case that the biometrics data captured is different than that existing in the ID Verification Transactional Back-end Database for that specific and unique wireless phone ID, is also sent into a watch-list of known fraudsters kept in the backend, which serves to identify and eliminate these fraudsters from potentially attacking financial systems both electronic and physical. The watch-list stores the data packets, as well as event logs of such fraud attempts.

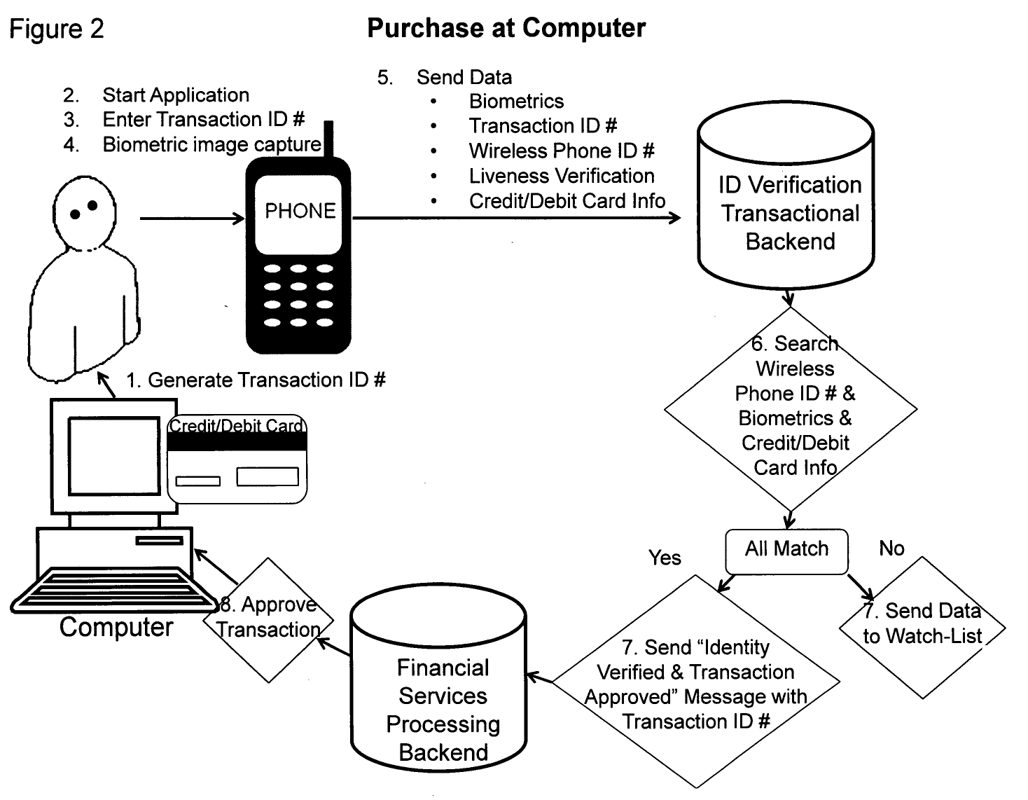

FIG. 2 illustrates a similar approach to secure purchases made online via a computer. The customer that has signed up for the service and has provided his/her biometrics, credit card/debit card/financial instrument and/or information and a unique ID code assigned to his/her wireless phone pays with his/her credit card/debit card/financial instrument and/or information online. A unique transaction ID number is assigned to the transaction. The customer initiates a dedicated application on his/her wireless phone and enters the transaction ID number. Then the customer acquires imagery of his/her biometrics with his/her phone. The application then fuses the transaction ID number with the biometric imagery acquired, along with the wireless phone ID number and a liveness verification of the biometrics acquired. The liveness verification is a method of ensuring that the biometrics just acquired are of an actual person and not from a photo or video.

The application then transmits the fused data to an “ID Verification Transactional Backend” which communicates with a database holding enrolled individuals' biometrics, credit card/debit card/financial instrument and/or information and wireless phone ID numbers as fused virtual packets. These data packets are indexed based on the wireless phone ID number.

The ID Verification Transactional Backend first performs a search of the wireless phone ID number against the ones stored in the database. Upon a match, the database proceeds to perform a search of the biometrics against those stored in the database followed by the same process for the credit card/debit card/financial instrument and/or information. A match at all three stages of the search returns an “identity verified” message.

The ID Verification Transactional Backend then sends an “Identity Verified” message to the Financial Services Processing Backend along with the ID number of the transaction that was just approved. The Financial Services Processing Backend then approves the online transaction and finalizes the purchase.

A no-match at any of the three stages of the search by the ID Verification Transactional Back-end leads to an “Identity Not Verified” message to the Financial Services Processing Backend which in turn does not authorize the online transaction. A no-match, in the case that the biometrics data captured is different than that existing in the ID Verification Transactional Back-end Database for that specific and unique wireless phone ID, is also sent into a watch-list of known fraudsters kept in the backend, which serves to identify and eliminate these fraudsters from potentially attacking financial systems both electronic and physical. The watch-list stores the data packets, as well as event logs of such fraud attempts.

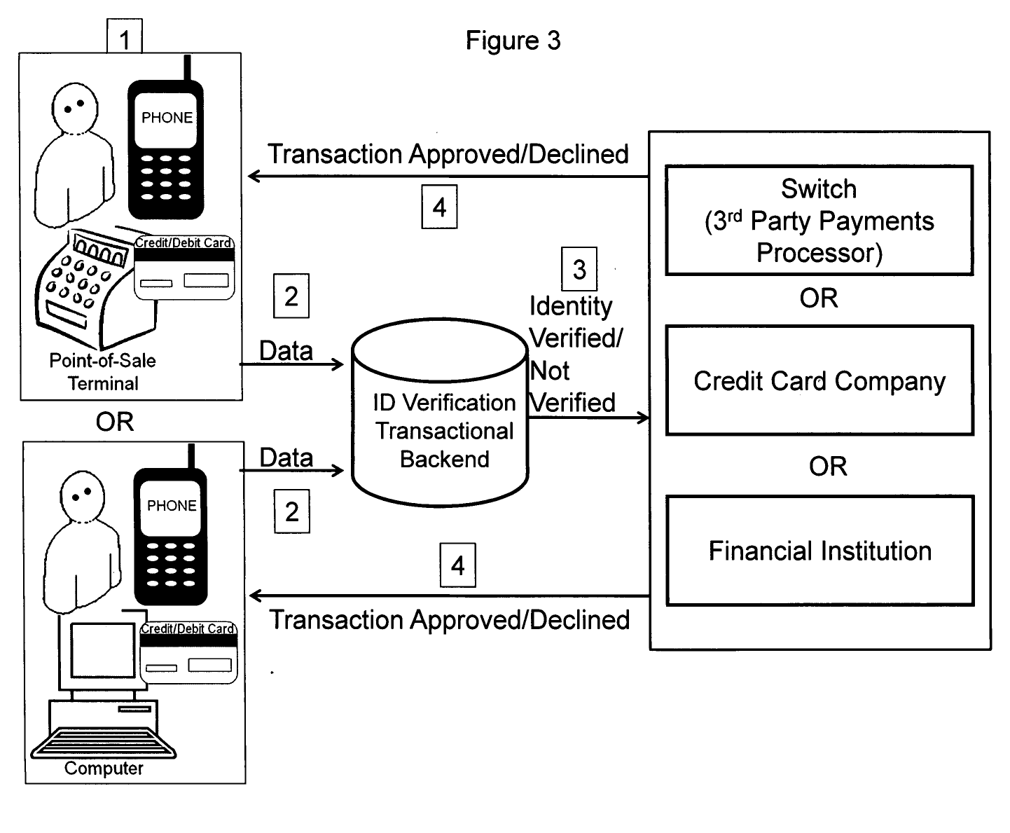

FIG. 3 presents the two approaches with various options for organizations that could handle back-end processing for the transactions: (a) For credit cards/debit cards/financial instruments issued by small-midsize banks, a third party processor (“switch”); (b) For credit cards/debit cards/financial instruments issued by small-midsize banks, the credit card company; and (c) For credit cards/debit cards/financial instruments issued by large banks, the banks themselves

The processing and financial segments of the transaction are handled by the financial back-end processors listed above and the wireless phone is used for identity verification only, as a unique identity verification tool that acquires biometrics information and matches it either locally or against a back-end central repository. Therefore, in case of a lost or stolen wireless phone, no identification and/or private information is compromised.

In a one-to many mode, the process described herein in FIG. 1 and FIG. 2 works exactly as described before, except that the application on the wireless device upon transmitting the fused data to an “ID Verification Transactional Backend” which communicates with a database holding enrolled individuals' biometrics, credit card/debit card/financial instrument and/or information, no wireless phone ID is sent. Instead the biometrics acquired are fused to the transaction ID, and then the ID Verification Transactional Backend first performs a one-to-many search solely of the biometrics received against all of the ones stored in the database. Upon a match, the database proceeds to perform a search of the credit card/debit card/financial instrument and/or information. A match at all two stages of the search returns an “identity verified” message.

The ID Verification Transactional Backend then sends an “Identity Verified” message to the Financial Services Processing Backend along with the ID number of the transaction that was just approved. The Financial Services Processing Backend then approves the online transaction and finalizes the purchase.

what is claimed is:

1. An identity verification system comprising:
a) A Point-of-Transaction Transmission Module b) A Biometric module for reading biometric data from a prospective customer c) An ID Verification Transactional Backend module capable of receiving data from the Biometric module and that performs processing to confirm or deny the identity of the prospective customer d) A Financial Services Processing backend module that is capable of receiving data from either or both of the ID Verification Transaction Backend module and the Point-of-Transaction Transmission Module e) A Point-of-Transaction Receiver Module that is capable of data input from either or both of the ID Verification Transaction Backend Module and the Financial Services Processing Backend Module

2. The method of claim 1 whereby the Point-of-Transaction Transmission module is capable of data entry from a credit card or other token-based reader module
